(19) United States
(12) Patent Application Publication
(10) Pub. No.: US 2005/0207658 A1
(43) Pub. Date: Sep. 22, 2005

(54) Method and apparatus for extracting information from a medical image

(75) Inventor: Bruce Schofield, Tyngsboro, MA (US)

Correspondence Address: JOHN C. GORECKI, ESQ., 180 HEMLOCK HILL ROAD, CARLISLE, MA, 01741, US

(73) Assignee: Nortel Networks Limited, St. Laurent (CA)

(21) Appl. No.: 10/794,136

(22) Filed: Mar. 5, 2004

(51) Int. Cl. G06K 9/36; G06F 17/60; G06K 9/00

(52) U.S. Cl. 382/232; 705/3; 382/128

(57) ABSTRACT

A method and apparatus for extracting information from a medical image data and transferring the extracted information in a separate format from the medical image data is disclosed. A network element is employed to monitor a network for medical image data transmitted on a network. The network element monitors the data packets on the data network to identify and retrieve the data packets containing medical image data. The medical image is reconstructed and the network element identifies and extracts desired information from within the medical image data. The network element then compresses the medical image data, and separately formats the extracted information from the medical image data. The medical image data and the extracted information are then transmitted to the image archive system via the network.

### BACKGROUND OF THE INVENTION

1. Field of the Invention

This invention generally relates to image management systems and, in particular, to a method and apparatus for extracting information from a medical image.

2. Description of the Related Art

Medical diagnostic imaging allows radiologists to perform diagnosis of many types of injury and disease by imaging various internal body parts. For example, radiologists utilize diagnostic imaging to visualize organs in the abdomen, the chest cavity, the brain and central nervous system, and the musculoskeletal system. Diagnostic imaging may be used to detect potential cancer abnormalities; bone densitometry; joint, bone, or soft tissue injuries; and many types of diseases. Presently, diagnostic imaging includes many different types of imaging technologies such as x-rays, ultrasound, computed tomography, magnetic resonance imaging, and nuclear medicine to name but a few.

Traditionally, almost all diagnostic imaging was film based. An image was recorded on a physical piece of film that had to be developed, provided to the physician for viewing, reviewed by the physician, and recorded and stored in an archive. Often there was a significant time delay between the taking of the image and the physician reviewing the image. In addition, the storage of film images required a large physical space and associated record keeping which, for example, may use paper files or files in a computer database. If a physician needed to refer to a patient's stored records, the film images needed to be physically found, retrieved, and provided to the physician. Often there was a significant time delay in this process as well.

To address these issues, diagnostic imaging technology has advanced and medical diagnostic imaging has shifted from a film based system, to a digitally based system in which diagnostic images are recorded, transferred, viewed, and stored electronically. A hard copy or print out of a diagnostic image may never need to be made. However, the storage of radiological images in digital format is a non-trivial problem due to the very large volume of data that these images contain. For example, projectional X-ray images require very high resolution to be clinically acceptable. Such images may be acquired and stored in image matrices of more than 2000 by 2000 pixels, with a dynamic range of 8 to 12 bits per pixel. This represents between 4 and 8 Mbytes per stored image. Digital imaging modalities such as computed tomography or magnetic resonance imaging currently generate images with smaller matrices (typically 256×256 or 512×512 with a dynamic range of 12 to 16 Bits per pixel), but generate very large numbers of images during each diagnostic examination that are then combined to form a three-dimensional volume image. Indeed, one examination can generate as few as twenty to in excess of more than one hundred images. This corresponds to storage requirements between 10 and 700 MBytes per diagnostic imaging event. Thus, the electronic database, storage, processing and network resources that are necessary to store, retrieve, transmit, and render a diagnostic image must be capable of handling large size files efficiently and quickly.

One image archiving system that has been developed to store and catalog the medical image files is generally referred to as a Picture Archiving and Communication System (PACS). A PACS provides an integrated system that receives image data from one or more imaging modalities, processes the image data as needed, stores the image data within a database, retrieves the data when required, and serves the data to be displayed for review by the physician or a technician. Thus, all images go through, and are managed by, the PACS. Because the PACS includes multiple pieces of equipment that are often manufactured by different manufacturers, a standard data format and protocol have been developed to allow communication and exchange of medical data among the various equipment manufacturers. This standard, developed by the American College of Radiologists and the National Electrical Manufacturers Association, is commonly referred to as Digital Imaging and Communications in Medicine (DICOM).

Among other things, the DICOM standard specifies the format and location of various data within an image file. FIG. 1 illustrates a portion of the format of a DICOM data message. As illustrated in FIG. 1, the DICOM data message contains a command portion 102 and a data portion 104. The data portion includes one or more data elements 102a, 102b . . . 102z and the data portion includes one or more data elements 104a, 104b . . . 104z. The command portion of the DICOM data message is configured to carry commands and instructions between DICOM service users that, in this context, are instructions to a DICOM service user as to how to manipulate the image pixel data. Each command element 102a-z includes a command element tag 106, a value length 108, and a value field 110. The command element tag 102 includes an ordered pair of numbers that uniquely identify a particular command element. The value length field 108 includes the number of bytes that make up the value field 110. The value field 110 includes the required value(s) of the command element defined by the command element tag.

Similarly, the data portion 104 includes a one or more data elements forming a header portion that includes image metadata, and one or more data elements forming a data portion that includes the image pixel data. Metadata in this context is data that is used to describe the data contained within the DICOM data message. For example, DICOM metadata may include both patient metadata and image metadata. Patient metadata can include the patient's name, gender, and age; the name of the radiologist; the name of the hospital; and other patient related data as needed. Image metadata can include data such as the acquisition device, the manufacturer of the device, the image acquisition date, the number of images, the size of the image(s), the field of view, and other machine dependent data as well.

Each data element in the data portion 104, whether it contains meta-data or image data, includes the same components: a data element tag 112, an optional value representation (VR) field 114, a value length field 116, and a value field 118. The data element tag 112 is an ordered pair of numbers that uniquely identify the particular data element. The VR field 114 is uniquely defined in the DICOM standard for each data element tag, or is used explicitly within the data element. The value field 118 includes the data value(s) specified by the respective data element tag 112.

Because the DICOM data messages contain very large amounts of data, manipulating and transferring these data messages across a network requires the allocation of considerable processing and network resources. Lossless compression may help to increase the efficiency of the network systems used to transfer an image file and to increase the efficiency of the storage systems used to store the image file by reducing the overall size of the image file. However as noted above, the DICOM protocol specifies that the command codes be embedded within the DICOM message. Thus, even when lossless compression is used to transmit an image file across a data network to a DICOM compliant PACS, the DICOM compliant PACS equipment must decompress the image file to retrieve the transaction/command code and then recompress the image file prior to storing the image. Thus, the PACS equipment is required to decompress the image file, extract the command code from the DICOM message, and re-compress the image file prior to storage. Given the size of diagnostic image files, this is a considerable amount of processing for the PACS equipment to undertake. In addition, because each image file is handled and managed by the PACS, the handling of many DICOM messages at once by the PACS may create a bottleneck due to the decompression, processing, and recompression by the PACS for each DICOM message. Accordingly, processing these files in this way may lead to increased network latency and delays in retrieving, storing, or rendering images.

### SUMMARY OF THE INVENTION

A method and apparatus for extracting information from a medical image is provided to reduce the decompression and extraction processing requirements on a networked medical device. According to one embodiment of the invention, a network element configured to provide a DICOM compression network service monitors the data network for data packets containing a DICOM data message and retrieves the identified data packets. The network element reconstructs the DICOM data message and extracts therefrom DICOM commands and if desired DICOM metadata. The network element then compresses the DICOM data message and separately formats the extracted commands and metadata. The DICOM data message and the separately formatted commands and metadata are then transmitted to an image archive system. By separating the commands and optionally meta data from the image data, the image archive system is able to access the extracted DICOM commands and metadata without having to decompress the entire DICOM data message. The separate formatting may include constructing a separate message and transmitting the extracted commands and metadata separately from the DICOM data message, or combining the extracted commands and metadata with the DICOM data message as a newly formatted header portion that is identified by a predetermined length or bit pattern or is compressed using a different compression scheme than the DICOM data message.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram illustrating the DICOM data message format;

FIG. 2 is a functional block diagram illustrating an example communication network incorporating an embodiment of the present invention;

FIG. 3 is a flow chart of a process for compressing medical images in accordance with an embodiment of the present invention;

FIG. 4 is a functional block diagram illustrating the DICOM data message format incorporating an embodiment of the present invention;

FIG. 5 is a functional block diagram illustrating the DICOM data message format incorporating an embodiment of the present invention; and

FIG. 6 is a functional block diagram of a network element according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been describe in detail so as not to obscure the invention.

A method and apparatus for extracting information from a medical image is provided to reduce the decompression and extraction processing requirements on a networked medical device. According to an embodiment of the invention, a network service is provided and configured to intercept DICOM data messages, decompress the DICOM message if required, extract the predetermined information, and compress or recompress the DICOM message prior to sending the message to the image archive system. The predetermined information, which may include command codes and/or metadata, and the DICOM message, are provided in separate formats to the image archive server to enable the image archive server to take actions in accordance with the extracted predetermined information without first decompressing the DICOM message to obtain access to the predetermined information. By extracting the predetermined information on the network with a network service, embodiments of the invention are able to reduce the decompression, extraction, and recompression requirements on the image archive server to accelerate processing of medical images.

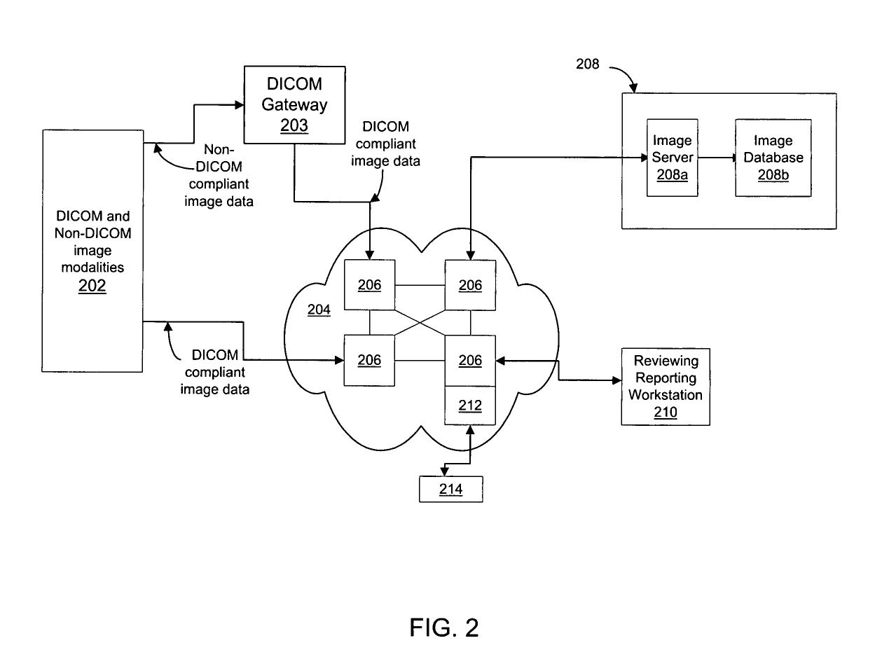

FIG. 2 illustrates an example of a network in which a compression service is coupled to a network element to extract the predetermined information from a medical image on behalf of an image archive system. As illustrated in FIG. 2, one or more imaging modalities 202 are configured to generate medical image data. The imaging modalities may include, without limitation, an x-ray system, a computer tomography system, an ultrasound system, a magnetic resonance imaging system, or a nuclear medicine system. Other modalities may be used and the invention is not limited to these particular modalities. The image modalities 202 may create medical image data in a DICOM compliant image data format, or a non-DICOM compliant image data format. In the event that the image data is in a non-DICOM compliant image data format, a DICOM gateway 203 reformats the non-DICOM compliant image data into DICOM compliant image data. The DICOM compliant image data is transferred to a desired destination for storage, processing, or display via a network 204 that is made up of one or more network elements 206. The network 206 may be an enterprise network, such as a Local Area Network that may be deployed in a medical facility or other facility. Examples of several typical networks may be a Hospital Information System (HIS) or a Radiological Information System (RIS). Alternatively, the network 106 may be a more extensive network such as a wide area network (“WAN”), a metro area network (“MAN”), a public network such as the Internet, or other large scale network.

The image data provided by the image modalities 202 can be provided to an image archive system 208 for storage or to a reviewing/reporting workstation 210 where the data may be displayed for review by a radiologist, or technician or other hospital or medical office employee. According to an embodiment of the present invention, a data extraction/compression network service (“the network service”) 212 is deployed on the network to provide real time image data compression functionality. The network service 212 may be located on or associated with one or more of the network elements 206 configured to communicate on the network or may be deployed elsewhere in network 204.

The network element 206 may be a router, bridge, gateway, content switch, or other types of network devices, at least one of which must be capable of providing the network service 212 with the required processing capability, control logic functions, and memory resources to perform the extraction/compression functionality described herein. Alternatively, as will be explained in more detail below, the network service 212 may be a blade server that is provided with an interface to the associated network element 206, but that has its own processor, memory, and control logic, and is capable of executing the functionality described herein in software, hardware, or a combination thereof.

The network element 206 associated with a network service 212 is preferably a content switch configured to filter data packets to identify particular packets and inspect the identified packets to determine their content. For example, a content switch may monitor the data packet traffic on the network 206 by setting filter values to identify packets on the network 206 that contain a destination address of the image archive system 208. The identified packets may be retrieved from the network 206 and stored in a memory within network element. The network element may then inspects the retrieved data packets to determine what type of data they contain. The invention is not limited to this embodiment however.

Since DICOM messages are generally relatively large, transmission of a DICOM message on the network 204 will typically require the DICOM message to be broken up into parts, each of which will be transported separately on the network. Depending on the type of network, different types of protocol data units may be used to transport the data over the network. A group of packets or other protocol data units that make up a complete DICOM image will be referred to herein as a flow. The network element 206 may be configured to filter packets or other protocol data units belonging to a flow and may be further configured to store the protocol data units until sufficient data has been received to enable the compression/extraction service 212 to begin to decompress the DICOM image and extract command codes and/or meta data from the DICOM image file. Depending on the type of compression used by the modalities and/or DICOM gateway, this may range from one packet to a complete DICOM image.

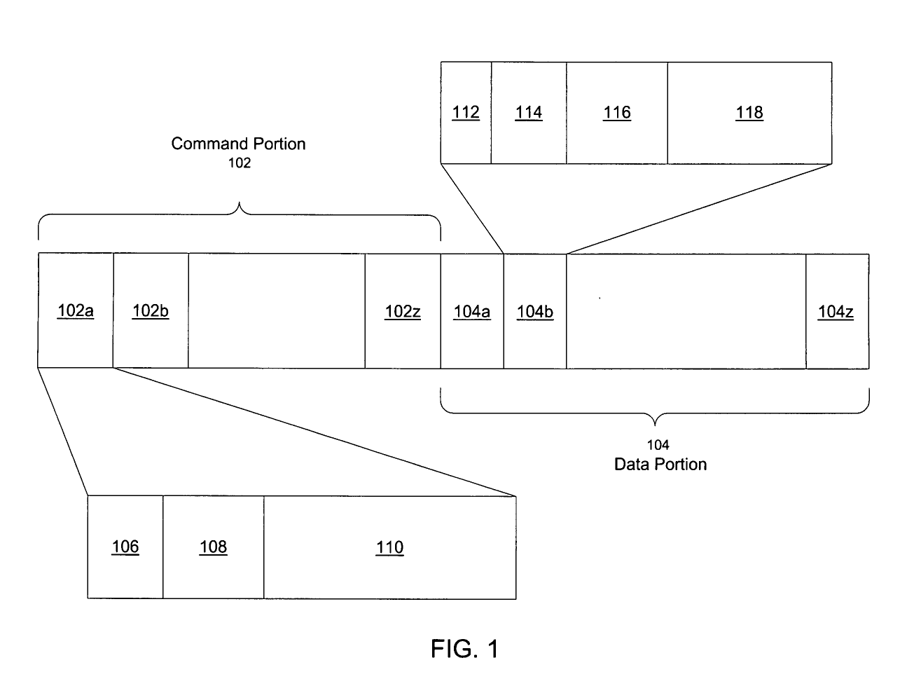

Once the compression/extraction service 212 has extracted the required information from the DICOM message, the compression/extraction service recompresses the DICOM data message for transmission over the network. The DICOM data message may be compressed using the same compression algorithm or a different compression algorithm. Optionally, the predetermined information may be separately compressed for transmission over the network as well, although the invention is not limited to this embodiment. As discussed in greater detail below, the extracted information may be prepended to the DICOM message, illustrated in FIG. 1, as a header portion 101. Alternatively, the extracted information may be appended or otherwise included in the message. The compressed DICOM data message and the extracted information that includes the DICOM commands and any desired metadata are forwarded to the image archive system 208 via the network 206. By separating the commands and/or metadata from the DICOM image, the image archiving system does not need to decompress the entire DICOM data message to access the extracted commands/metadata. Even where the commands and metadata are compressed, the amount of decompression required by the image archiving system may be greatly reduced since the data portion of the message may remain compressed.

The image archive system 208 may includes one or more additional components such as an image archive server 208a and an image archive database 208b to catalog and archive the received images. While the imaging archive server is illustrated in FIG. 2 as preferably being a PACS system, the invention is not limited to this embodiment as other types of image archiving server may be used as well.

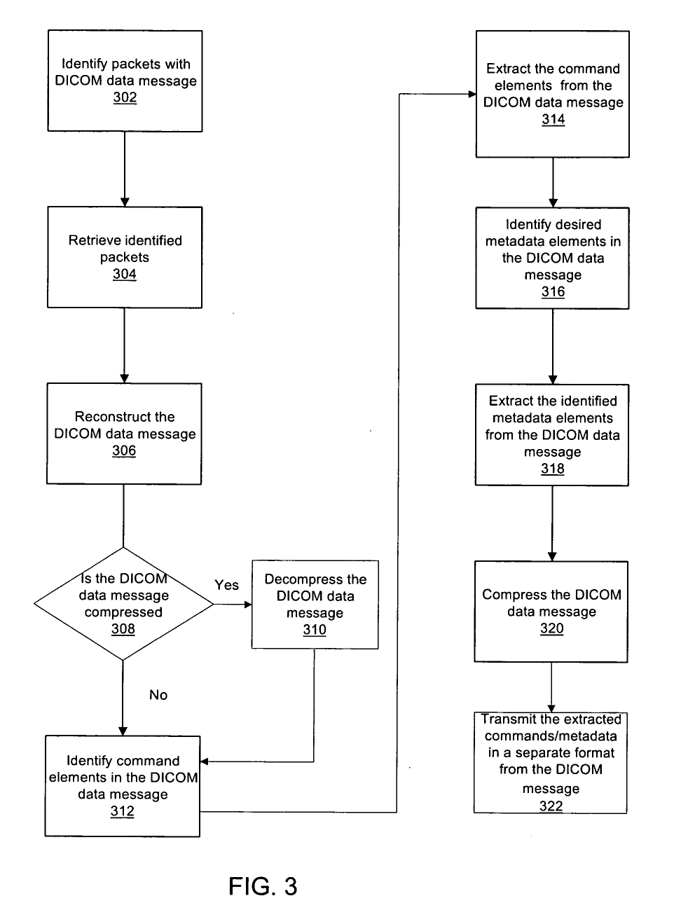

FIG. 3 illustrates a flowchart of a process of extracting information from a DICOM message according to an embodiment of the invention. The process may be implemented in software, hardware, firmware, in a combination thereof, or in another manner. In the illustrated embodiment, data packet traffic on the network is monitored and data packets containing DICOM data messages are identified (302). Data packets identified as containing DICOM data messages (304) are retrieved or filtered from the general stream of data packets and used, where necessary, to reconstruct a DICOM message or a portion of the DICOM message (306). Depending on the implementation, reconstruction of the DICOM message may be required to enable decompression, extraction, and compression operations to be performed on the DICOM message.

If the DICOM data message is in a compressed form (308), the DICOM data message is decompressed (310). The decompressed or received DICOM message is then parsed to identify command elements within the DICOM data message by matching tag identifiers within the DICOM data message with a list of predetermined command tags (312). Optionally, the command tags may be defined within the DICOM standard (312) although other command tags may be used as well and disseminated to the image transmission participants on the network. The command elements are then extracted from the DICOM data message (314).

If metadata elements are to be extracted from the DICOM data message, the desired metadata elements are identified within the DICOM data message, for example by matching tag identifiers within the DICOM data message with a predefined list of metadata tags (316). The metadata tags may be defined by the DICOM standard or defined by the participants in the system. Once identified, the metadata elements are extracted from the DICOM data message (318).

To more efficiently transport the DICOM message on the network, the DICOM message may then be compressed in a suitable fashion (320) and passed back onto the network for transmission to the image archive system (322).

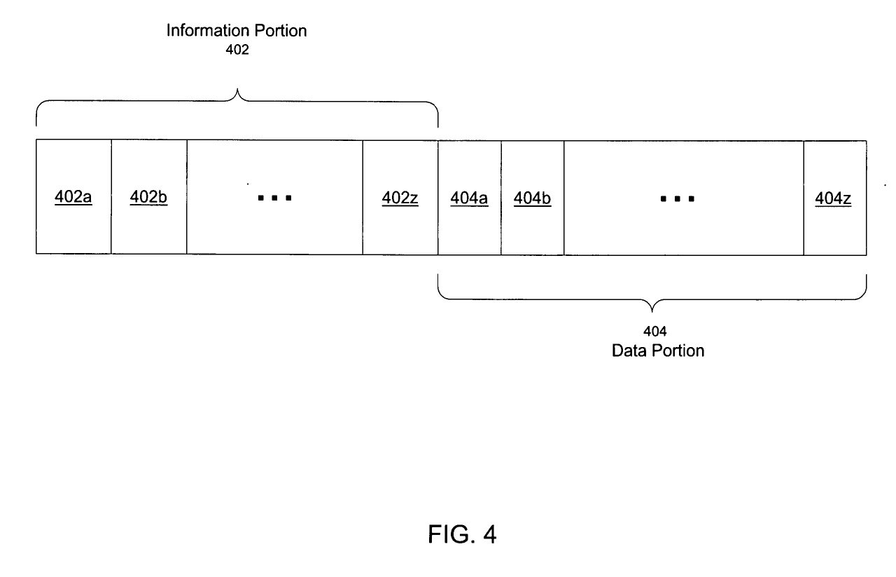

As discussed above, the extracted commands and desired metadata are transmitted in a separate format from the compressed DICOM data message. As used herein, a separate format means that the extracted information is either transmitted in a separate message from the compressed DICOM data message or may be included in the DICOM data message as a newly formatted and identified message portion that is able to be accessed without the necessity of decompressing the entire DICOM data message. For example, FIG. 4 illustrates a DICOM message having newly formatted information portion 402 that includes the extracted commands and metadata 402a-402z. The information portion 402 may be compressed using a different compression scheme than the remaining DICOM data message, or, alternatively, may be left uncompressed. Although the newly formatted information portion 402 is illustrated as being placed at the front of the DICOM data message, the newly formatted information portion 402 could be placed anywhere in the DICOM data message that is convenient so long as it is properly identified.

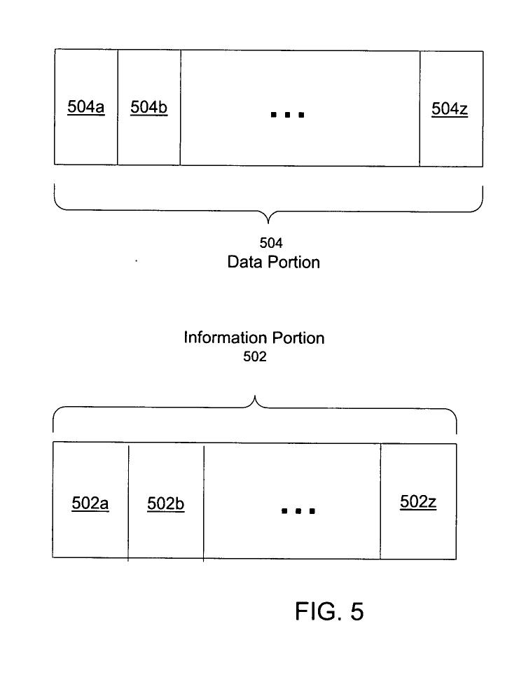

Alternatively, as illustrated in FIG. 5, the extracted information is formatted as a separate information message 502 from the DICOM data message 504. The information message 502 includes the extracted information 502a-502b and the DICOM data message includes the image data 504a-504z. The information message 502 can be compressed using a suitable compression scheme, or may be left uncompressed. The information message 502 the data message formatted according to the DICOM protocol and may be transmitted either as a standard DICOM message or transmitted as an out of band signal. The data message may be compression of the DICOM data message 504 can be accomplished using a suitable compression scheme that may be either lossy or lossless so long as the image archive system is capable of storing and decompressing the DICOM data message when needed.

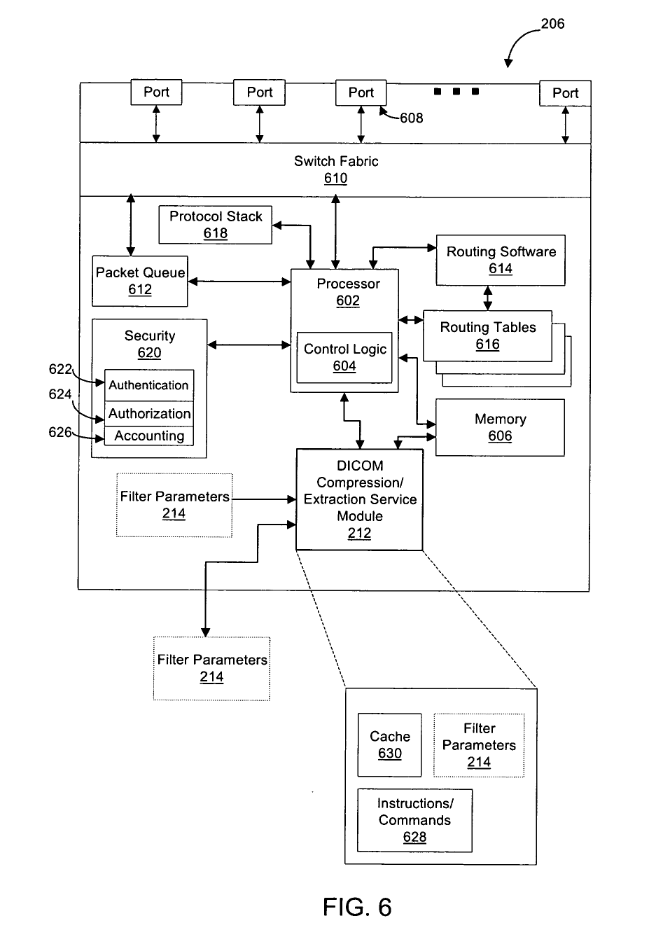

FIG. 6 depicts a network element according to an embodiment of the present invention. In particular the network element 206 illustrated in FIG. 6 generally includes a processor 602, which includes control logic 604, and a memory 606. The processor 602, control logic 604 and memory 606 provide the functionality and control of the network element. The network element 206 also includes one or more network data ports 608 that enable the network element 206 to be connected to the network 204. A switch fabric 610 under the control of the processor 602, is provided to interconnect the network data ports 608 and to direct packets therebetween. The switch fabric 610 may be supported by a packet queue 612 that is configured to temporarily store packets or other protocol data units prior to transmission on the network or before being processed by the processor 602.

The network element 206 may also include one or more subsystems under the control of the processor 602 and control logic 604. For example, if the network element is configured to make routing decisions over the network, routing software 614 and routing tables 616 containing routing information may be provided to enable the network element to route data packets and other protocol data units on the network. Other subsystems may include for example a protocol subsystem that includes a protocol stack 618 that is configured to store data and instructions to enable the network element to participate in protocol exchanges on the network. The network element 206 may also include a security subsystem 620 that may include an authentication module 622 that is configured to store authentication information to authenticate users, devices, network connections, or a combination thereof. The security subsystem 620 may further include an authorization module 624 that is configured to provide authorization information to prevent unauthorized access to the network, the network element, or both. The security subsystem 620 may also include an accounting module 626 that is configured to enable accounting entries to be established for sessions on the network, the network element, or both.

As illustrated in FIG. 6, the network device 206 is configured to perform the compression service, which has been described above in greater detail in connection with FIGS. 1-3. In particular, a compression service module 212 is coupled to the processor 602, control logic 604, and memory 606 of the network device 206. In addition, the compression service module 212 is further coupled to a storage device 214 that is configured to contain the filter parameters to enable the network element to identify the various packets on the network. The storage device 214 may be external to network device 206 as illustrated in FIG. 2 included within the network element 206 or included as part of the network service module 212.

The compression service module 212 includes instructions and commands 628 sufficient to implement the functionality described above. The network service may also include cache memory 630 and the storage location of the filter parameters 214.

The compression service may be implemented to be native to the network element 206 as illustrated in FIG. 6, or as may be a separate computing platform that utilizes the network element to interface the network. For example, the compression service module 212 may be a blade server that is associated with the network element 206. Accordingly the blade server includes the necessary instructions and commands to implement the functionality described above, along with a processor, sufficient memory, and any required control logic. The separate computing platform may be associated with other network services or may be implemented in a dedicated stand-alone network device. The invention is thus not limited to the manner in which the compression/extraction service is implemented on, or associated with, the network element.

The functions described above may be implemented as a set of program instructions that are stored in a computer readable memory within the network element and executed on one or more processors within the network element. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be appreciated that other variations to and modifications of the above-described method and system for extracting information from a medical image may be made without departing from the inventive concepts described herein. Accordingly, the invention should not be viewed as limited except by the scope and spirit of the appended claims.

1. A method for extracting information from a medical image, the method comprising the steps of:
receiving by a network element data packets containing image data;
reconstructing by the network element at least a portion of the image data from the retrieved data packets;
extracting by a network service in conjunction with the network element predetermined information from the reconstructed image data;
formatting by the network service in conjunction with the network element, the data message into a first format;
formatting by the network service in conjunction with the network element the extracted information into a second format; and
transmitting the data message in the first format to the image archive system and the extracted information in the second format.

2. The method of claim 1 wherein the step of receiving by a network element comprises the steps of:
monitoring, by the network element, a network for data packets containing the image data;
identifying, by the network element, data packets on the network containing the image data; and
retrieving, by the network element, from the network the identified data packets.

3. The method of claim 1 wherein the step of transmitting the extracted information includes transmitting the extracted information in an out of band signal.

4. The method of claim 1 wherein the step of extracting the predetermined information comprises the step of extracting predetermined commands from the image data.

5. The method of claim 1 wherein the predetermined information comprises metadata from the image data.

6. The method of step 1 wherein the step of formatting the image data in a first format, includes formatting the image data using a first compression scheme.

7. The method of step 1 wherein the step of formatting the extracted information includes formatting the extracted information using a second compression scheme.

8. The method of claim 1 wherein the step of formatting the extracted information includes formatting the extracted information without a compression scheme.

9. The method of claim 1, wherein the image archive system is a picture archive and communication system (PACS) device.

10. A system for extracting information from a medical image transmitted on a network, the system comprising:
a network element coupled to the network; and
a compression/extraction service associated with the network element and configured to:
receive a data packet containing image data;
reconstruct a portion of the image data from the retrieved packet;
extract predetermined information from the image data;
format the image data in a first format;
format the extracted information in a second format; and
transmit the image data in the first format and the extracted information in the second format to the image archive system.

11. The system of claim 10 wherein to receive data packets, the network element is further operative to:
monitor a network for a data packet containing image data;
identify data packets on the network containing the image data; and
retrieve the data packets identified as containing the image data.

12. The method of claim 11 wherein the network element is further configured to extract metadata from the image data.

13. The method of step 12 wherein the network element is further configured to format the image data using a first compression scheme.

14. The method of claim 10 wherein the network element is configured to transmit the extracted commands in an out of band signal.

15. The method of step 10 wherein the network element is further configured to format the extracted information using a second compression scheme.

16. The method of claim 10 wherein the network element is further configured to format the extracted information without compressing the extracted information.

17. The method of claim 10, wherein the image server and database system is a picture archive and communication system (PACS) device.

18. The system of claim 10 wherein the network element is operative to transmit the DICOM extracted commands in an out of band signal.
